(19) United States
(12) Patent Application Publication
(10) Pub. No.: US 2022/0003617 A1
(43) Pub. Date: Jan. 6, 2022

(54) TORQUE DETECTION SENSOR

(71) Applicant: SHINANO KENSHI KABUSHIKI KAISHA, Nagano (JP)

(72) Inventor: Akihide FURUKAWA, Nagano (JP)

(21) Appl. No.: 17/317,491

(22) Filed: May 11, 2021

(30) Foreign Application Priority Data
Jul. 3, 2020 (JP) 2020-115481

(51) Int. Cl. G01L 3/10; H01F 27/26

(52) U.S. Cl. CPC G01L 3/102; H01F 27/266

(57) ABSTRACT

A plurality of teeth are provided to protrude in staggered arrangement in an annular core in a circumferential direction, coils are respectively wound around the respective teeth, and when the respective coils are energized, corresponding teeth are excited to thereby form a plurality of magnetic circuits having an inclination of +45 degrees or −45 degrees with respect to an axial center direction of an object to be detected between the teeth and the facing object to be detected.

### CROSS-REFERENCE TO RELATED APPLICATION

This application is based upon and claims the benefit of priority of the prior Japanese Patent Application No. 2020-115481, filed on Jul. 3, 2020, and the entire contents of which are incorporated herein by reference.

### TECHNICAL FIELD

The present invention relates to a self-excitation torque detection sensor.

### BACKGROUND ART

There exists a magnetostrictive torque detection device as a method for detecting torque acting on an object to be detected such as a rotary shaft by a non-contact manner. For example, surface treatment (for example, plating, grooving, or the like) for increasing magnetostrictive characteristics is performed on the surface of a shaft to be the object distortion of which is detected, and magnetostrictive effect is measured to detect the torque. The measurement of the magnetostrictive effect is executed by arranging coils coaxially wound around the shaft and reading variation in magnetic permeability of the shaft generated by Villari effect based on the magnitude of impedance.

As the torque detection device, the applicants have proposed a magnetostrictive torque detection sensor in which magnetic paths formed between the sensor and a plurality of cores assembled to insulation cylindrical bodies so that the magnetic paths formed at the object to be detected have a prescribed angle with respect to its axis center are respectively increased to thereby improve torque detection sensitivity. The plural cores are disposed in an inclined manner at a prescribed angle with respect to an axial center direction of the object to be detected so that end faces of both side leg portions face the object to be detected from inner circumferential surfaces of the insulation cylindrical bodies. As the cores formed in a U-shape are disposed in the inclined manner at the prescribed angle with respect to the axial center of the object to be detected, an independent magnetic path passing one leg portion (end surface), the object to be detected, the other leg portion (end surface), and a bridge portion is formed. As described above, the same magnetic field is generated around the coil as the same coil passes through the plural cores, which forms the same pole.

Accordingly, an undesired magnetic path is not formed and magnetic fluxes are concentrated to the cores, and a magnetic path connecting adjacent cores to each other is not easily formed; therefore, a structure in which detection sensitivity is improved can be obtained (PTL 1: Japanese Patent No. 6483778).

### SUMMARY OF INVENTION

### Technical Problem

However, in the torque detection device of the above patent literature, it is necessary to form grooves on an outer peripheral surface of the insulation cylindrical bodies and to wind the plural detection coils along the grooves, and further, the plural cores are assembled to the insulation cylindrical bodies so that the detection coils pass through a U-shaped space surrounded by the bridge portion connecting the leg portions.

Accordingly, it is necessary to embed the detection coils and the cores by utilizing the thickness of the insulation cylindrical bodies in a radial direction; therefore, the sensor tends to be increased in size in the radial direction and an axial direction. As the end faces of both side leg portions forming the cores are provided so as to face the object to be detected, the shape of end faces has to be, not a flat surface, but an arc-shaped curved surface, which increases processing costs.

There is also a demand that torque is delicately detected without reducing detection sensitivity over the entire periphery of the object to be detected.

### Solution to Problem

In response to the above issue, one or more aspects of the present invention are directed to a self-excitation torque detection sensor capable of reducing the size of the sensor and being mass produced at low cost as well as capable of detecting compressive stress and/or tensile stress generated over the entire periphery of an object to be detected without reducing detection sensitivity.

In view of the above, the following embodiments are described below.

A torque detection sensor measures variation of magnetic permeability by variation of coil impedance in magnetic circuits formed between a core and an object to be detected by energizing coils wound around teeth provided to protrude from the annular core provided around the object to be detected at plural places, in which a plurality of teeth are provided to protrude in staggered arrangement in the annular core in a circumferential direction, the coils are wound around the respective teeth, and, when the respective coils are energized, corresponding teeth are excited to thereby form a plurality of magnetic circuits having an inclination of +45 degrees or −45 degrees with respect to an axial center direction of the object to be detected between the teeth and the facing object to be detected.

According to the above configuration, the plural teeth are provided to protrude in staggered arrangement in the annular core in the circumferential direction, and the teeth adjacent in the circumferential direction are excited to different magnetic poles and a plural magnetic paths having the inclination of +45 degrees or −45 degrees with respect to the axial center direction are formed between the teeth and the facing object to be detected by energizing the coils connected to a same energizing circuit in series which are wound around the respective teeth. Accordingly, it is possible to detect compressive stress and tensile stress generated over the entire periphery of the object to be detected. Even when a magnetic circuit coming from an N-pole tooth and returning to a S-pole tooth through the object to be detected is formed in the circumferential direction, the magnetic circuit has a magnetic path component that makes little contribution to torque detection; therefore, detection sensitivity is hardly affected.

It is preferable that the coils connected to the same energizing circuit in series are wound around the plural teeth, and that the teeth adjacent in the circumferential direction are alternately excited to N-poles and S-poles.

Accordingly, as long as the teeth around which the coils connected to the same energizing circuit in series are wound and adjacent in the circumferential direction are alternately excited to N-poles and S-poles, the plural coils can be continuously wired, for example, in one stroke line, which increases wiring variation and makes wiring easy.

It is also preferable that the core includes a first core, an intermediate core, and a second core, that plural first teeth formed in the first core in the circumferential direction and plural second teeth formed in the second core in the circumferential direction are stacked through the intermediate core, and that the first teeth and the second teeth are provided to protrude in staggered arrangement in the circumferential direction.

The first core and the second core can be manufactured through similar manufacturing processes to a laminated core used for a stator core of a motor, which can be reduced in size in a radial direction and an axial direction and can be mass produced at low cost. Moreover, the intermediate core is provided between the first core and the second core, thereby providing a space for winding. Accordingly, the number of turns of coils to be wound around the first teeth and the second teeth can be increased, which generates more magnetic fluxes and improves detection sensitivity.

The torque detection sensor may be a self-excitation sensor measuring variation of magnetic permeability by variation of coil impedance in magnetic circuits formed between the teeth and the object to be detected by energizing coils wound around the plural teeth provided to protrude in the core in staggered arrangement.

In this case, it is possible to detect compressive stress or tensile stress acting on the object to be detected by energizing the coils at arbitrary timing.

A torque detection sensor measuring variation of magnetic permeability by variation of coil impedance in magnetic circuits formed between a plurality of annular cores provided around an object to be detected and the object to be detected by energizing coils wound around teeth provided to protrude from the plural annular cores at plural places has a first torque detection part including a first core, an intermediate core, and a second core, in which a plurality of first teeth formed in the first core in a circumferential direction and a plurality of second teeth formed in the second core in the circumferential direction are stacked through the intermediate core, the first teeth and the second teeth are provided to protrude in the circumferential direction in staggered arrangement, the coils are respectively wound around the respective teeth, the teeth are excited by energization to the respective coils, and a plurality of magnetic circuits having an inclination of +45 degrees with respect to an axial center direction are formed between the teeth and the facing object to be detected, and a second torque detection part including a third core, an intermediate core, and a fourth core, in which a plurality of third teeth formed in the third core in the circumferential direction and a plurality of fourth teeth formed in the fourth core in the circumferential direction are stacked through the intermediate core, the third teeth and the fourth teeth are provided to protrude in the circumferential direction in staggered arrangement, the coils are respectively wound around the respective teeth, the teeth are excited by energization to the respective coils, and a plurality of magnetic circuits having an inclination of −45 degrees with respect to the axial center direction are formed between the teeth and the facing object to be detected, in which the first torque detection part and the second torque detection part are stacked through the intermediated core so that the first torque detection part and the second torque detection part are arranged in mirror symmetry with respect to a symmetry plane orthogonal to the axial center direction of the object to be detected.

According to the above structure, the adjacent first teeth and second teeth are excited to different magnetic poles and a plural magnetic paths having the inclination of +45 degrees with respect to the axial center direction are formed between the teeth and the facing object to be detected by energizing the coils of the first torque detection part, and the adjacent third teeth and fourth teeth are excited to different magnetic poles and the plural magnetic paths having the inclination of −45 degrees with respect to the axial center direction are formed between the teeth and the facing object to be detected by energizing the coils of the second torque detection part. Accordingly, it is possible to detect compressive stress and tensile stress generated over the entire periphery of the object to be detected.

When the first torque detection part in which the plural magnetic paths having the inclination of +45 degrees are formed and the second torque detection part in which the plural magnetic paths having the inclination of −45 degrees are formed are stacked so that they are arranged in mirror symmetry with respect to the symmetry plane orthogonal to the axial center direction of the object to be detected, the magnetic paths having the inclination of +45 degrees formed between the first teeth and the second teeth and the magnetic paths having the inclination of −45 degrees formed between the third teeth and the fourth teeth through energization can detect the torque without canceling out magnetic fluxes with each other.

The first teeth, the intermediate core, and the second teeth forming the first torque detection part, and the third teeth, the intermediate core, and the fourth teeth forming the second torque detection part can be manufactured in similar manufacturing processes to the stator core of the motor, which can be reduced in size in the radial direction and the axial direction and can be mass produced at low cost.

When the intermediate core is provided between the plural teeth, the number of turns of coils to be respectively wound around the first teeth to the fourth teeth can be increased, which generates more magnetic fluxes and improves detection sensitivity.

When the teeth adjacent to each other in the axial center direction through the symmetry plane are excited to the same magnetic pole in the first torque detection part and the second torque detection part, the second teeth and the fourth teeth at symmetrical positions in the axial center direction through the symmetry plane have the same magnetic pole; therefore, the magnetic path crossing the symmetry plane between the second teeth and the fourth teeth is not formed in the axial center direction of the object to be detected, which does not reduce the detection sensitivity.

When the teeth adjacent to each other in the axial center direction through the symmetry plane are excited to different magnetic poles in the first torque detection part and the second torque detection part, the second teeth and the fourth teeth at symmetrical positions in the axial center direction through the symmetry plane have different magnetic poles; therefore, magnetic paths crossing the symmetry plane between the second teeth and the fourth teeth are formed in the axial center direction of the object to be detected. However, the magnetic paths have magnetic path components making little contribution to torque detection, which does not affect the detection sensitivity.

It is preferable that the first torque detection part and the second torque detection part are self-excitation sensors measuring variation of magnetic permeability by variation of coil impedance in magnetic circuits formed between the teeth and the object to be detected by respectively energizing coils wound around the teeth provided to protrude in the plural cores in staggered arrangement.

In this case, the coils wound around the teeth provided to protrude in staggered arrangement in the first torque detection part and the second torque detection part are energized at arbitrary timing, thereby detecting compressive stress and tensile stress acting on the object to be detected.

### Advantageous Effects of Invention

It is possible to provide a self-excitation torque detection sensor capable of reducing the size of the sensor and being mass produced at low cost as well as capable of detecting compressive stress and/or tensile stress generated over the entire periphery of an object to be detected without reducing detection sensitivity.

### BRIEF DESCRIPTION OF DRAWINGS

FIGS. 1A to 1C are a front view, a cross-sectional view taken along an arrow Y-Y, and a perspective view of a torque detection sensor.

FIGS. 2A to 2C are front view, a right-side view, and a cross-sectional view taken along an arrow Y-Y of the torque detection sensor.

FIGS. 3A and 3B are views showing arrangement of teeth provided to protrude in a circumferential direction of a core and arrangement of magnetic poles formed by energization.

FIGS. 4A to 4C are wiring diagram of a plurality of coils wound around a plurality of teeth of FIGS. 3A and 3B.

FIG. 5 is an arrangement view of magnetic poles formed by coil energization.

FIGS. 6A to 6G are an exploded front view, cross-sectional views taken along an arrow X-X, an exploded perspective view, a front view of a first core, an exploded cross-sectional view in an arrow X-X direction, and an end view of the first core in a torque detection sensor according to another embodiment;

FIGS. 7A to 7C are explanatory views showing assembly configurations of cores and teeth according to other embodiments.

FIGS. 8-1A to 8-1C are a front view, a side view, and a perspective view showing exploded states of a torque detection sensor according to another embodiment.

FIGS. 8-2A to 8-2C are a front view, a cross-sectional view taken along an arrow Y-Y, and a perspective view of the torque detection sensor of FIGS. 8-1A to 8-1C.

FIGS. 9A to 9C are a front view, a right-side view, and a perspective view of a torque detection sensor according to another example.

FIGS. 10A to 10D are a front view, a right-side view, a cross-sectional view taken along an arrow Y-Y, and a perspective view of a torque detection sensor according to another example.

FIG. 11 is an explanatory view of arrangement of teeth provided to protrude in a circumferential direction of a core in FIGS. 9A to 9C and magnetic paths formed by energization.

FIG. 12 is an explanatory view of arrangement of teeth provided to protrude in the circumferential direction of a core and magnetic paths formed by energization according to another example of FIG. 11.

FIG. 13 is a comparative arrangement view of magnetic poles formed at the teeth by energization, which is not capable of being applied to the torque detection sensor of FIG. 1.

FIG. 14 is a comparative arrangement view of cores and magnetic poles formed at the teeth by energization, which is not capable of being applied to the torque detection sensor of FIG. 9.

FIG. 15 is a comparative arrangement view of cores and magnetic poles formed at the teeth by energization, which is not capable of being applied to the torque detection sensor of FIG. 9.

FIGS. 16A to 16C are a front view, a right-side view, and a perspective view of a torque detection sensor and an object to be detected according to another embodiment.

### DESCRIPTION OF EMBODIMENTS

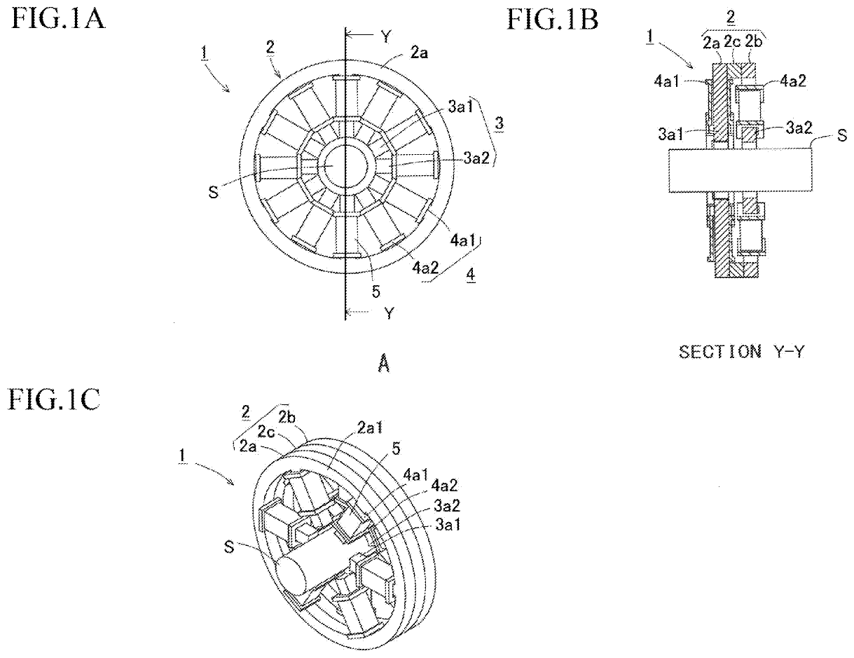

Hereinafter, a torque detection sensor according to an embodiment of the present invention will be explained with reference to the attached drawings. First, a schematic configuration of a magnetostrictive torque detection sensor will be explained with reference to FIGS. 1A, 1B.

As an example of an object to be detected S, a material with high inverse magnetostrictive effect is preferable. For example, there are permendur, Fe—Al (ALFE), Fe—Nix (permalloy), spherical graphite cast iron (JIS: FCD70), and the like as materials with high inverse magnetostrictive effect. The inverse magnetostrictive effect is a phenomenon in which magnetic characteristics are changed when stress is added to a magnetic body from the outside. When magnetic annealing is previously performed to the object to be detected S according to need, the torque acting on the object to be detected S can be suitably detected, which will be described in detail later. Even in a non-magnetic material, the torque can be detected by coating the material with a metal magnetic material by performing thermal spraying or by press-fitting a magnetic cylinder into a shaft. The object to be detected S illustrated in FIGS. 1A to 1C as an example has a columnar shape, but the shape is not limited to this. An internal structure does not matter as long as the object to be detected S has the columnar shape. For example, a cylindrical shape in which an inner diameter is fixed in an axial direction or a cylindrical shape in which the inner diameter differs according to positions in the axial direction may be adopted. Moreover, the object to be detected S may be an object expected to rotate as well as an object not expected to rotate.

Furthermore, the object to be detected S may be a solid shaft material as well as an air-core cylindrical body.

As shown in FIGS. 1A to 1C, a magnetostrictive torque detection sensor 1 is concentrically assembled so as to cover an outer periphery of the object to be detected S. A plurality of teeth 3 are provided to protrude in staggered arrangement in an annular core 2 in a circumferential direction, and coils 5 connected to a same energizing circuit in series are respectively wound around the respective teeth 3 through insulators 4. When the respective coils 5 are energized, the teeth 3 adjacent in the circumferential direction are excited to different magnetic poles (N-pole or S-pole), and a plurality of magnetic paths having an inclination of +45 degrees or −45 degrees with respect to an axial center direction are formed between the teeth 3 and the facing object to be detected S.

As the torque detection sensor 1, a self-excitation torque detection sensor is used, which measures variation of magnetic permeability by variation of coil impedance in magnetic circuits formed between the teeth 3 and the object to be detected S by energizing the coils 5 wound around the teeth 3 facing the object to be detected S at plural positions therearound.

Configurations of the core 2 and the teeth 3 will be explained. The core 2 and the teeth 3 may be, for example, formed by stacking electromagnetic steel sheets which is press molded, or may be integrally formed from a magnetic material in a block shape. It is also preferable to use the core 2 and the teeth 3 manufactured by using a sintered body, metal powder injection molding, and green compact. A configuration of a laminated type will be explained below. In a first core 2a, first teeth 3a1 provided to protrude in an annular core back portion 2a1 toward an inner side in a radial direction are provided at six places in total with a phase difference of 60 degrees in the circumferential direction. A cylindrical first insulator 4a1 made of insulating resin is fitted to each of the first teeth 3a1 and the coil 5 is wound therearound.

In a second core 2b, second teeth 3a2 are provided to protrude in an annular core back portion 2b1 toward the inner side in the radial direction are provided at six places in total with the phase difference of 60 degrees in the circumferential direction in the same manner as the first core 2a. A cylindrical second insulator 4a2 made of insulating resin is fitted to each of the second teeth 3a2 and the coil 5 is wound therearound.

Phase differences between respective teeth may be the same as well as different from one another. The number of teeth may be an even number as well as an odd number, but the even number is effective as the teeth are alternately excited to N-poles and S-poles in the circumferential direction as described later. An annular intermediate core 2c is provided between the first core 2a and the second core 2b. The intermediate core 2c doubles as a spacer for securing a space where the coils 5 are wound around the cores between the first core 2a and the second core 2b and magnetic paths between the first core 2a and the second core 2b. The intermediate core 2c is not provided with teeth protruding toward the inner side in the radial direction.

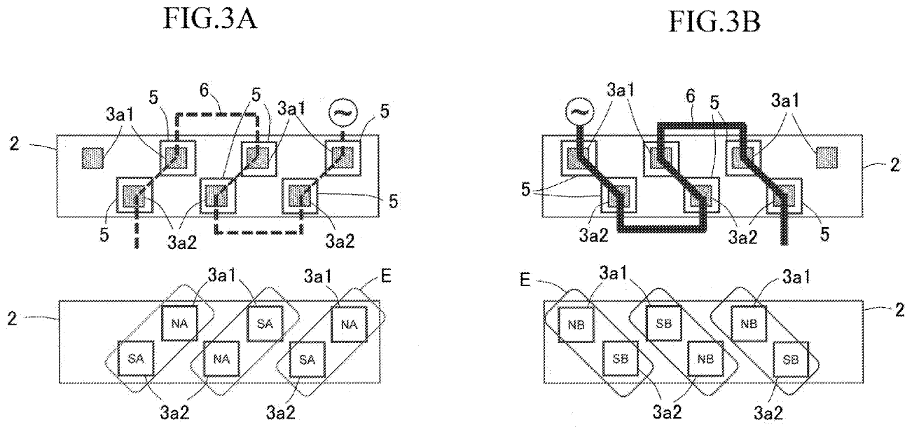

The first core 2a and the second core 2b are stacked through the intermediate core 2c and integrally joined by caulking, adhesion, or combinations of them to form the core 2. The first teeth 3a1 and the second teeth 3a2 adjacent to each other are stacked so that the phase differs by 45 degrees in the circumferential direction. More precisely, tip portions of the first teeth 3a1 facing the object to be detected S and tip portions of the second teeth 3a2 facing the object to be detected S are stacked through the intermediated core 2c so that the phase differs by 45 degrees in the circumferential direction. Accordingly, on an inner peripheral surface of the core 2, the first teeth 3a1 and the second teeth 3a2 are provided to protrude in staggered arrangement in the circumferential direction as shown in developed views of FIGS. 3A and 3B.

An upper stage of FIG. 3A shows arrangement of the teeth 3 (the first teeth 3a1 and the second teeth 3a2) for measuring stresses in a tensile direction (CW direction) and a compressive direction (CCW direction) in a simplified manner. The coils 5 wound around the respective teeth 3 are connected to the same energizing circuit 6 in series, and the first teeth 3a1 or the second teeth 3a2 adjacent in the circumferential direction are excited to different magnetic poles (N-pole or S-pole) from each other by energizing the coils 5 by AC power as shown in a lower stage of FIG. 3A. The coils 5 will be explained as A coils in this case. NA in the drawing shows the A coil excited to N-pole and SA shows the A coil excited to S-pole. Whether being excited to N-pole or excited to S-pole can be determined by inverting the direction in which the A coils are wound around the teeth 3. A long frame E surrounding NA and SA represents an inclination of magnetic paths with respect to an axial center direction (a vertical direction in the drawing) in the magnetic paths formed between the object to be detected and the first teeth 3a1/the second teeth 3a2 (for example, the inclination of magnetic paths of +45 degrees).

An upper stage of FIG. 3B shows arrangement of the teeth 3 (the first teeth 3a1 and the second teeth 3a2) for measuring stresses in the tensile direction (CW direction) and the compressive direction (CCW direction) in the simplified manner. The coils 5 wound around the respective teeth 3 are connected to the same energizing circuit 6 in series, and the first teeth 3a1 or the second teeth 3a2 adjacent in the circumferential direction are excited to different magnetic poles from each other (N-pole or S-pole) by energizing the coils 5 by AC power as shown in a lower stage of FIG. 3B. The coils 5 will be explained as B coils in this case. NB in the drawing shows the B coil excited to N-pole and SB shows the B coil excited to S-pole. Whether being excited to N-pole or excited to S-pole can be determined by inverting the direction in which the B coils are wound around the teeth 3. A long frame E surrounding NB and SB represents an inclination of magnetic paths with respect to the axial center direction (the vertical direction in the drawing) in the magnetic paths formed between the object to be detected and the first teeth 3a1/the second teeth 3a2 (for example, the inclination of magnetic paths of −45 degrees).

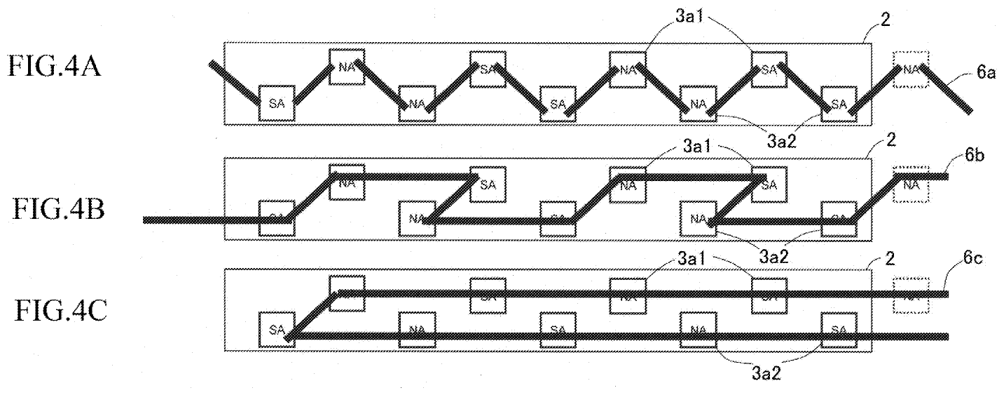

FIGS. 4A, 4B, and 4C show examples of energization patterns with respect to the coils 5 wound around the respective teeth 3 (the first teeth 3a1 and the second teeth 3a2) in developed views of the core 2. Black lines in the drawings represent the coils 5, and the coils 5 are wound around the teeth 3, though not shown in the drawings. The poles to which the teeth are excited are changed by inverting the direction in which the coils 5 are wound around the teeth 3 similarly to the explanation of FIGS. 3A and 3B. In the plural teeth 3 provided to protrude in staggered arrangement in the core 2 in the circumferential direction, the teeth 3 around which the coils 5 connected to the same energizing circuit in series are wound are preferably alternately excited to N-poles and S-poles adjacent to each other in the circumferential direction. Accordingly, as long as the teeth 3 adjacent in the circumferential direction around which the coils 5 connected to the same energizing circuit in series are wound are alternately excited to N-poles and S-poles, the plural coils 5 can be continuously wired, for example, in one stroke line as explained below, which increases wiring variation and makes wiring easy.

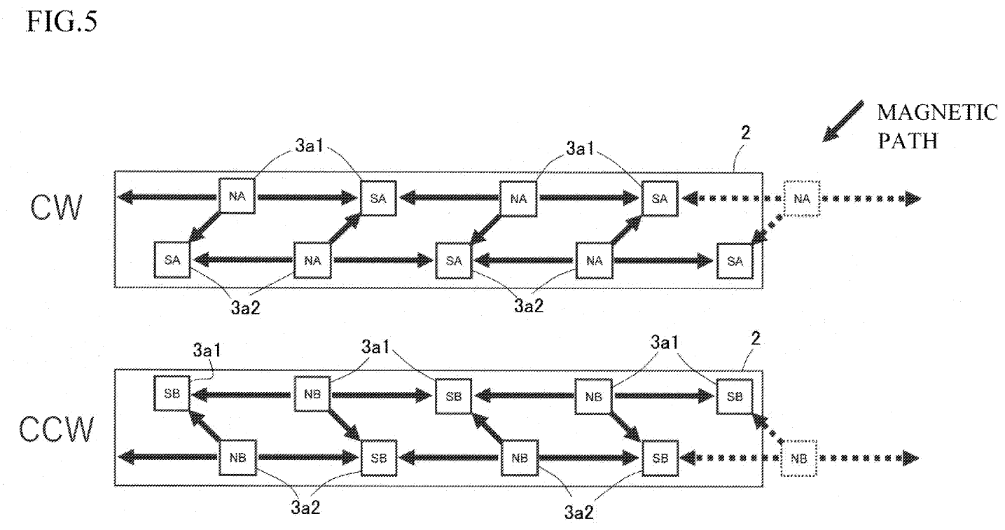

FIG. 4A illustrates an energizing circuit 6a that energizes the coils in a zigzag shape in the first teeth 3a1 and the second teeth 3a2 and magnetic poles (-SA-SA-NA-NA . . . ) formed in the first teeth 3a1 and the second teeth 3a2 as an example. FIG. 4B illustrates an energizing circuit 6b that energizes the coils in a square-wave shape in the first teeth 3a1 and the second teeth 3a2 and magnetic poles (-SA-NA-SA-NA . . . ) formed in the first teeth 3a1 and the second teeth 3a2 as an example. FIG. 4C illustrates an energizing circuit 6c that energizes the coils from the first teeth 3a1 in the circumferential direction, then, the second teeth 3a2 by making a U-turn, and magnetic poles (-SA-NA-SA-NA- . . . ) formed in the first teeth 3a1 and the second teeth 3a2 as an example. In all energizing patterns illustrated in FIGS. 4A to 4C, magnetic paths making the most contribution to torque detection are magnetic paths formed between the first teeth 3a1 and the second teeth 3a2 arranged with a phase difference of ±45 degrees in the circumferential direction (see FIG. 5). In a case where there is no constraint even if the sensitivity is reduced, the phase difference does not have to be ±45 degrees, but the phase difference may be, for example, ±30 degrees or the like.

FIG. 5 shows developed views of the core 2 of the torque detection sensor 1 in the CW direction and the CCW direction, and arrows in the drawings represent magnetic paths formed in the first teeth 3a1 and the second teeth 3a2.

In the torque detection sensor 1 in the CW direction shown in an upper stage of FIG. 5, magnetic paths generated between different magnetic poles (between NA and SA) in the circumferential direction of the first teeth 3a1 and magnetic paths generated between different magnetic poles (between NA and SA) in the circumferential direction of the second teeth 3a2 have magnetic path components making little contribution to torque detection. Accordingly, these magnetic paths have little effect on detection sensitivity.

Similarly, in the torque detection sensor 1 in the CCW direction shown in a lower stage of FIG. 5, magnetic paths generated between different magnetic poles (between NB and SB) which are adjacent in the circumferential direction of the first teeth 3a1 and magnetic paths generated between different magnetic poles (between NB and SB) which are adjacent in the circumferential direction of the second teeth 3a2 have magnetic path components not making a contribution to torque detection. Accordingly, these magnetic paths have little effect on detection sensitivity.

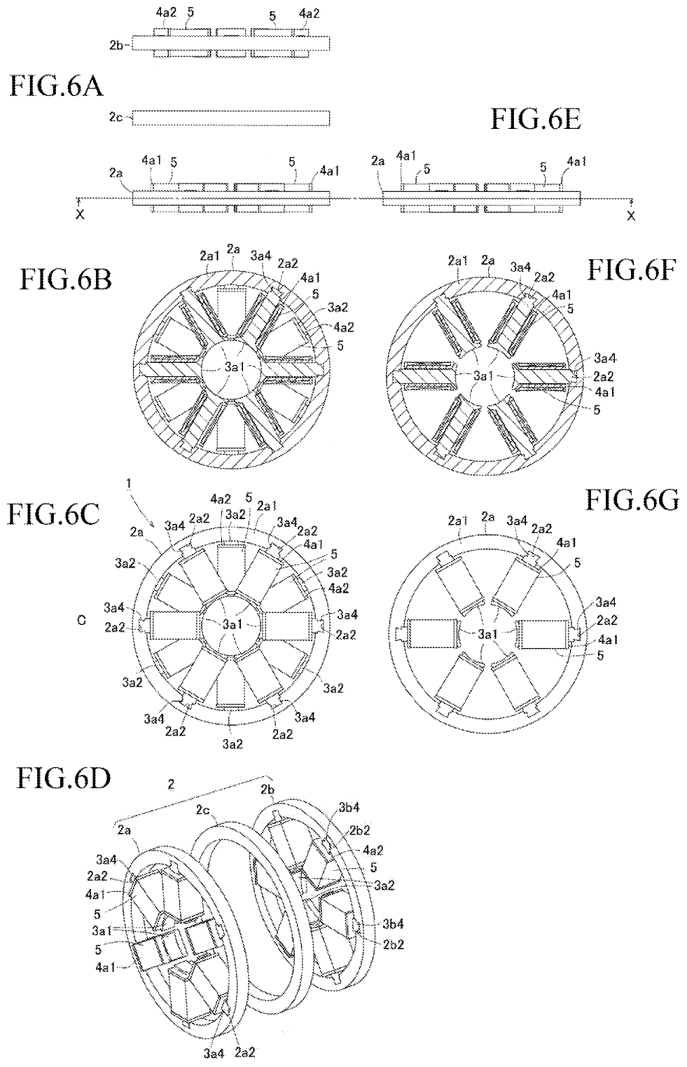

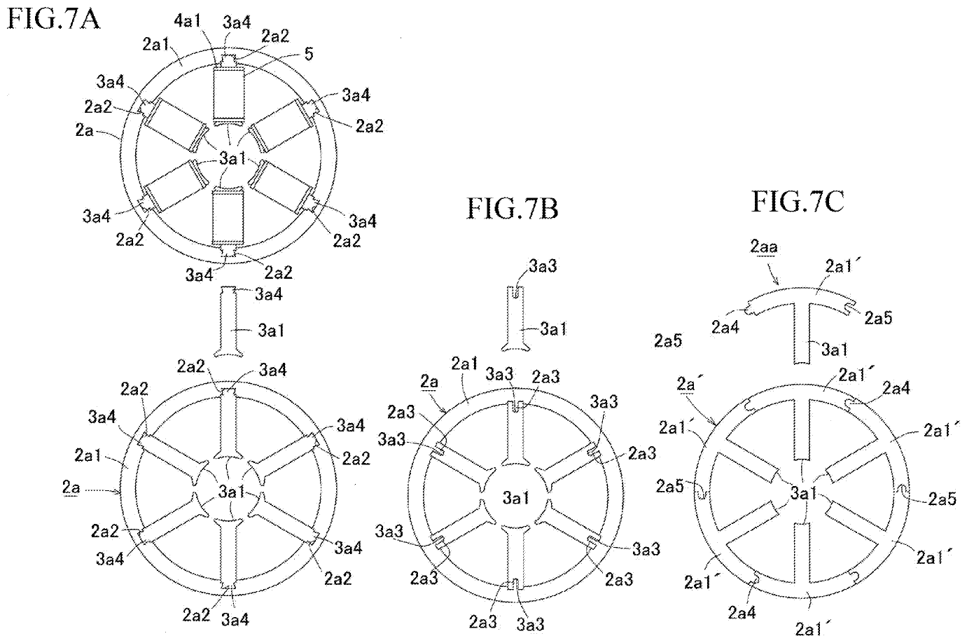

Here, other configuration examples of the torque detection sensor 1 will be explained with reference to FIGS. 6A to 6G, and FIGS. 7A to 7C. FIGS. 6A to 6G are an exploded front view, cross-sectional views taken along an arrow X-X, an exploded perspective view, a front view of the first core, an exploded cross-sectional view in an arrow X-X direction, and an end view of the first core in the torque detection sensor.

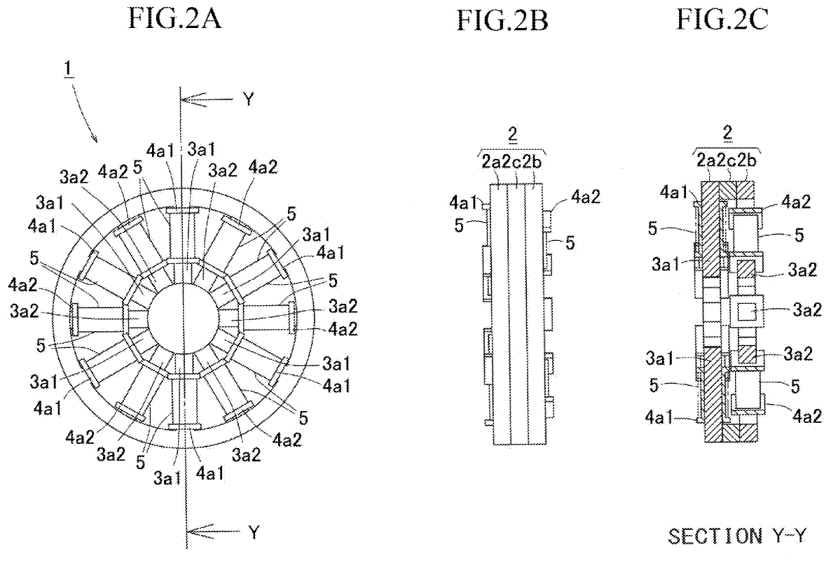

In FIG. 6A, the configuration is the same as the one shown in FIG. 2A to FIG. 2C in a point that the core 2 is formed by stacking the annular first core 2a, intermediate core 2c, and second core 2b; however, the configuration differs from FIGS. 2A to 2C in a point that the first teeth 3a1 are not integrally formed with the core back portion 2a1, and the second teeth 3a2 are not integrally formed with the core back portion 2b1 as shown in FIGS. 6B to 6D.

As shown in FIGS. 6E to 6G, the plural first teeth 3a1 are provided to protrude toward the inner side in the radial direction in the first core 2a with a phase difference of 60 degrees in the circumferential direction, which are provided at six places in total. As shown in FIG. 6D, the plural second teeth 3a2 are provided to protrude toward the inner side in the radial direction in the second core 2b with the phase difference of 60 degrees in the circumferential direction, which are provided at six places in total in the same manner.

As shown in FIGS. 6A and 6D, the first core 2a and the second core 2b are stacked through the intermediate core 2c, and the first teeth 3a1 and the second teeth 3a2 are stacked with a phase difference of 45 degrees in the circumferential direction to be integrally assembled. A state of the torque detection sensor 1 after assembly is shown in FIG. 6C.

FIGS. 7A, 7B, and 7C are explanatory views showing assembly configurations of the cores and the teeth according to other embodiments. As shown in FIG. 7A, the first teeth 3a1 are assembled so that engaging portions 3a4 provided at outer end portions of the first teeth 3a1 are fitted in the axial center direction into dovetail grooves 2a2 provided on an inner peripheral surface of the core back portion 2a1. In each of the first teeth 3a1, the first insulator 4a1 is fitted in a state of being removed from the core back portion 2a1, and the coil 5 is wound around the first insulator 4a1. This is assembled so that the engaging portion 3a4 is fitted in the axial center direction into the dovetail groove 2a2 formed in the core back portion 2a1 of the first core 2a. As for an assembly structure of the second teeth 3a2 with respect to the core back portion 2b1 of the second core 2b, the second teeth 3a2 are assembled by fitting engaging portions 3b4 into dovetail grooves 2b2 in the axial center direction in the same manner as the first teeth 3a1 (see FIG. 6D).

Moreover, as shown in FIG. 7B, it is also preferable that projections 2a3 are formed on the inner peripheral surface of the core back portion 2a1 and recesses 3a3 are provided at outer end portions in the radial direction of the first teeth 3a1 and that the projections 2a3 are fitted into the recesses 3a3 to thereby assemble the first teeth 3a1 to the core back portion 2a1 toward the inner side of the radial direction. In this core state, the degree of freedom in assembling the first teeth 3a1 to the first core 2a and assembling the second teeth 3a2 to the second core 2b is high; therefore, assemblability is good.

As shown in FIG. 7C, it is also preferable that core segments 2aa on which the first teeth 3a1 are provided to protrude in the radial direction are connected in a ring shape to core back portions 2a1′ each divided in an arc shape, instead of the annular core back portion 2a1, to thereby assemble a first core 2a′. A second core 2b′ (not shown) is assembled in the same manner.

A projection 2a4 is formed at one end in the circumferential direction of the core back portion 2a1′ of each core segment 2aa, and a recess 2a5 is formed at the other end in the circumferential direction. It is also preferable that the core segments 2aa in which insulators are fitted to the first teeth 3a1 and coils (not shown) are wound therearound are fitted to one another so that the projections 2a4 are fitted to the recesses 2a5 to thereby assemble the first core 2a′. Accordingly, the winding work with respect to the teeth becomes easy, and assemblability is improved as the core segments 2aa have the common structure.

FIGS. 8-1A to 8-1C are explanatory views showing assembly configurations of a torque detection sensor according to another embodiment, and FIGS. 8-2A to 8-2C show a front view, a cross-sectional view taken along an arrow Y-Y, and a perspective view of the torque detection sensor of FIGS. 8-1A to 8-1C.

In the above embodiment, the annular first core 2a, intermediate core 2c, and second core 2b with the same diameter are stacked in the axial direction to be integrally assembled as the core 2 in the same manner as FIGS. 2A to 2C; however, it is also preferable that, for example, an outer diameter of the intermediate core 2c is larger than those of the first core 2a and the second core 2b, and that the first core 2a and the second core 2b are concentrically fitted from both end openings of the intermediate core 2c.

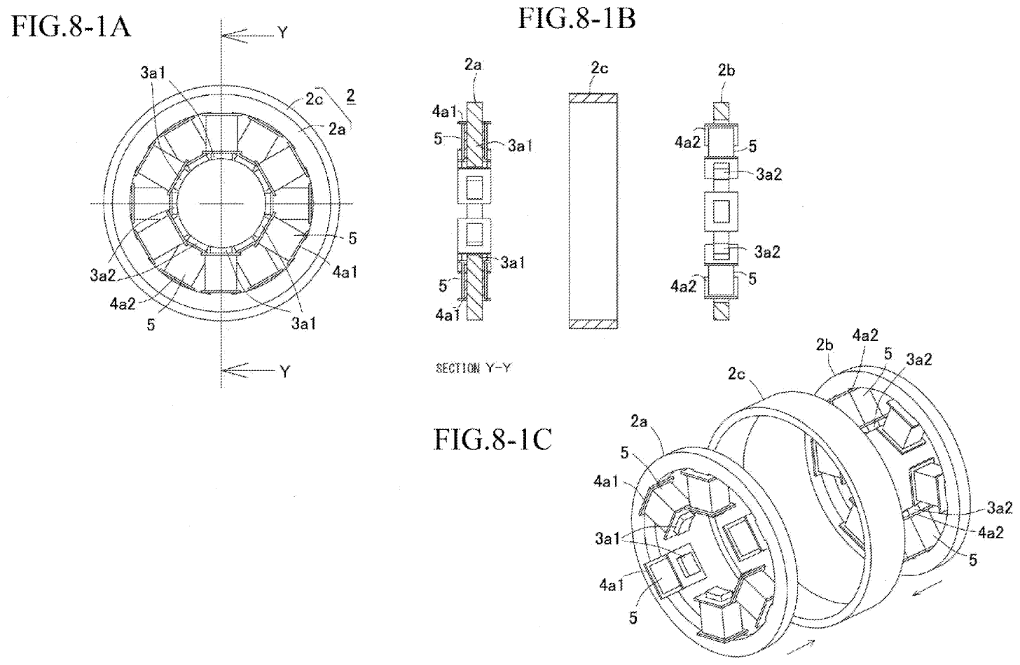

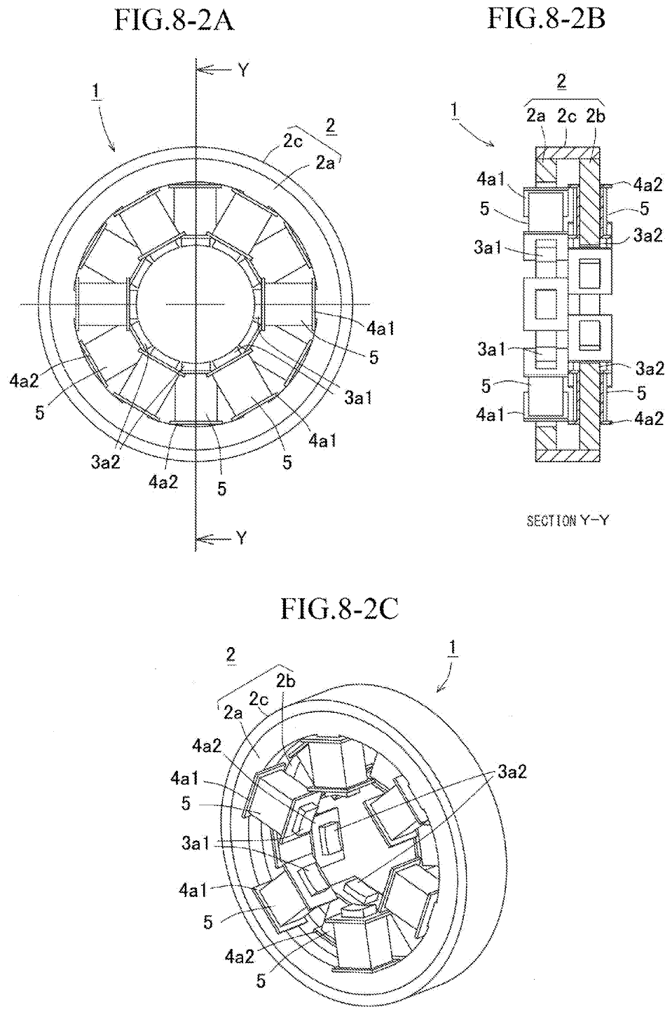

FIGS. 8-1A to 8-1C show a front view of an opening end, a side view, and a perspective view showing an exploded state before the first core 2a and the second core 2b are inserted to the intermediate core 2c. FIGS. 8-2A to 8-2C show the front view of the opening end, the cross-sectional view taken along the arrow Y-Y, and the perspective view showing a state where the first core 2a and the second core 2b are fitted to the intermediate core 2c from the both end openings. FIGS. 8-1C and 8-2C are perspective views showing states before and after the first core 2a and the second core 2b are inserted to the intermediate core 2c. As shown in FIG. 8-2B, the first core 2a and the second core 2b inserted from the both end openings of the intermediate core 2c may be fitted with prescribed gaps. As the intermediate core 2c is also the magnetic body, magnetic circuits are formed in the first teeth 3a1 and the second teeth 3a2 in which the phase differs by 45 degrees through the intermediate core 2c.

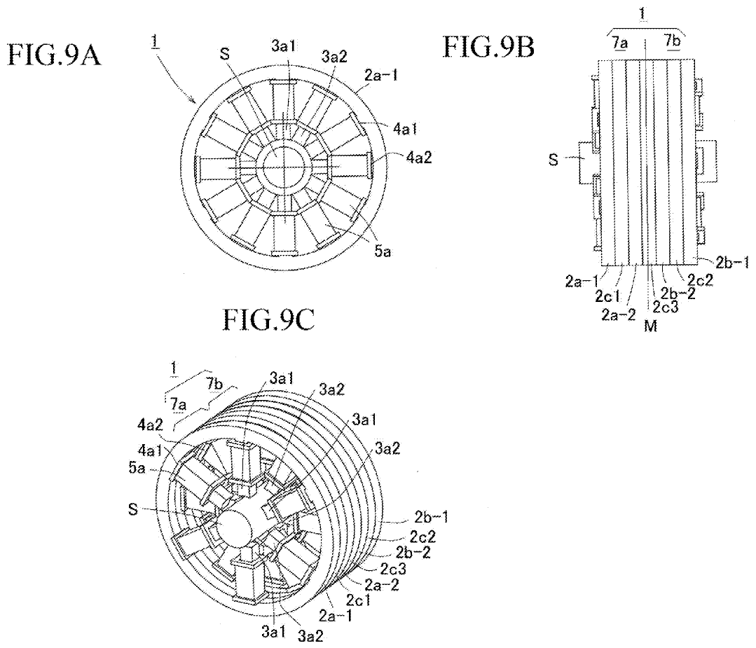

Next, another embodiment of the torque detection sensor 1 will be explained with reference to FIGS. 9A to 9C to FIG. 12.

The embodiment also relates to the self-excitation torque detection sensor 1 that measures variation of magnetic permeability by variation of coil impedance in the magnetic circuits formed between the core 2 and the object to be detected S by energizing the coils 5 wound around the teeth 3 provided to protrude from the annular core 2 provided around the object to be detected S at plural positions.

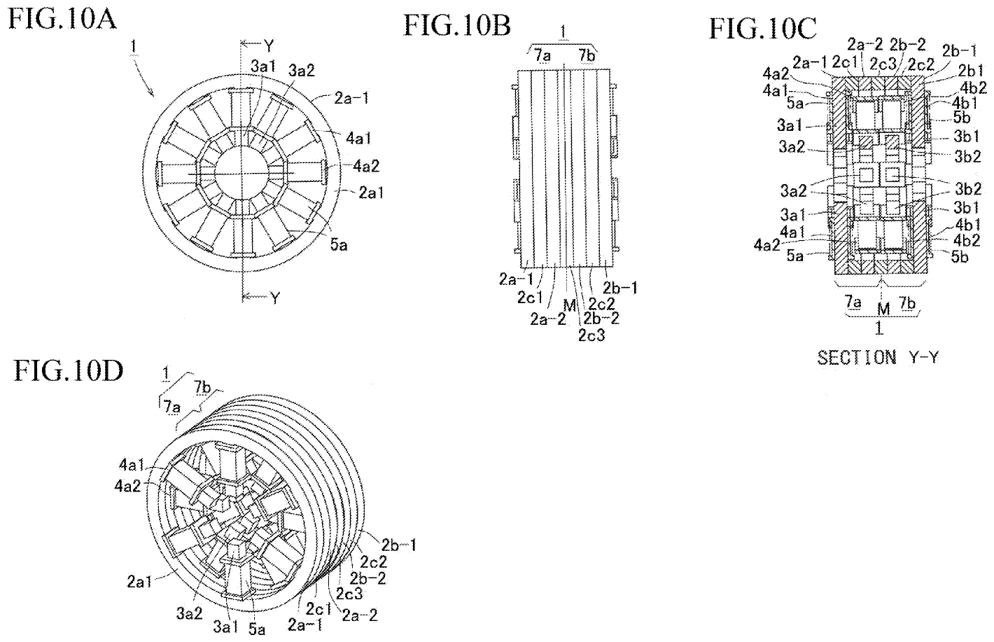

In FIG. 9C and FIG. 10C, a first toque detection part 7a is configured so that the plural first teeth 3a1 and second teeth 3a2 are provided to protrude in an annular first core 2a-1 and an annular second core 2a-2 in the circumferential direction toward the inner side in the radial direction. The first teeth 3a1 and the second teeth 3a2 are provided in staggered arrangement by stacking the first core 2a-1 and the second core 2a-2 through an intermediate core 2c1. The first insulators 4a1 and the second insulators 4a2 are respectively fitted around the respective first teeth 3a1 and the second teeth 3a2, and first coils 5a connected to the same energizing circuit are respectively wound therearound. The first teeth 3a1 and the second teeth 3a2 adjacent to each other are excited to different magnetic poles by energizing the respective first coils 5a to thereby form a plurality of magnetic paths having the inclination of +45 degrees with respect to the axial center direction between the teeth and the facing object to be detected S.

A second toque detection part 7b is configured so that plural third teeth 3b1 and fourth teeth 3b2 are provided to protrude in an annular third core 2b-1 and an annular fourth core 2b-2 in the circumferential direction toward the inner side in the radial direction. The third teeth 3b1 and the fourth teeth 3b2 are provided in staggered arrangement by stacking the third core 2b-1 and the fourth core 2b-2 through an intermediate core 2c2. Third insulators 4b1 and fourth insulators 4b2 are respectively fitted around the respective third teeth 3b1 and the fourth teeth 3b2, and second coils 5b connected to the same energizing circuit are respectively wound therearound. The third teeth 3b1 and the fourth teeth 3b2 adjacent to each other in the circumferential direction are excited to different magnetic poles by energizing the respective second coils 5b to thereby form a plurality of magnetic paths having the inclination of −45 degrees with respect to the axial center direction between the teeth and the facing object to be detected S.

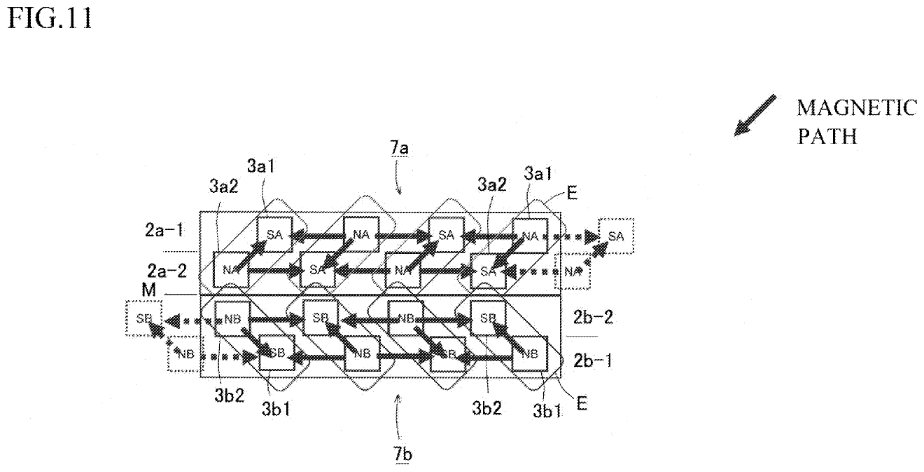

The first toque detection part 7a and the second torque detection part 7b are stacked so that they are arranged in mirror symmetry with respect to a symmetry plane M orthogonal to the axial center direction (the vertical direction of the drawing) of the object to be detected S as shown in a developed view of the first core 2a-1, the second core 2a-2, the third core 2b-1, and the fourth core 2b-2 in FIG. 11.

In FIGS. 10A and 10D, the first teeth 3a1 provided to protrude in the annular core back portion 2a1 toward the inner side in the radial direction are provided at six places in total with the phase difference of 60 degrees in the circumferential direction in the first core 2a-1. The cylindrical first insulators 4a1 made of insulating resin are fitted to the respective first teeth 3a1 and the first coils 5a are wound therearound.

As shown in FIGS. 10B and 10C, the first core 2a-1 is stacked on the second core 2a-2 through the intermediate core 2c1. The second teeth 3a2 provided to protrude in the annular core back portion 2a1 toward the inner side in the radial direction are provided at six places in total with the phase difference of 60 degrees in the circumferential direction in the second core 2a-2. The cylindrical second insulators 4a2 made of insulating resin are fitted to the respective second teeth 3a2 and the first coils 5a are wound therearound.

In the first core 2a-1 and the second core 2a-2, the first teeth 3a1 and the second teeth 3a2 are stacked so that phases are displaced by +45 degrees in the circumferential direction (see an upper stage of a developed view of the core in FIG. 11).

In FIG. 10C, the third teeth 3b1 provided to protrude in the annular core back portion 2b1 toward the inner side in the radial direction are provided at six places in total with the phase difference of 60 degrees in the circumferential direction in the third core 2b-1 in the same manner as the first core 2a-1. The cylindrical third insulators 4b1 made of insulating resin are fitted to the respective third teeth 3b1 and the second coils 5b are wound therearound.

As shown in FIG. 10C, the third core 2b-1 is stacked on the fourth core 2b-2 through the intermediate core 2c2. The fourth teeth 3b2 provided to protrude in the annular core back portion 2b1 toward the inner side in the radial direction are provided at six places in total with the phase difference of 60 degrees in the circumferential direction in the fourth core 2b-2. The cylindrical fourth insulators 4b2 made of insulating resin are fitted to the respective fourth teeth 3b2 and the second coils 5b are wound therearound.

In the third core 2b-1 and the fourth core 2b-2, the third teeth 3b1 and the fourth teeth 3b2 are stacked so that phases are displaced by −45 degrees in the circumferential direction (see a lower stage of the developed view of the core in FIG. 11).

As shown in FIG. 9B and FIG. 10B, the second core 2a-2 and the fourth core 2b-2 are stacked through an annular intermediate core 2c3. The intermediate cores 2c1, 2c2, and 2c2 double as spacers where the first coils 5a are wound around the first teeth 3a1 and the second teeth 3a2 or the second coils 5b are wound around the third teeth 3b1 and the fourth teeth 3b2 between the first core 2a-1 and the second core 2a-2, between the third core 2b-1 and the fourth core 2b-2, or between the second core 2a-2 and the fourth core 2b-2, and magnetic paths generated between the first core 2a-1 and the second core 2a-2, between the third core 2b-1, and the fourth core 2b-2, or between the second core 2a-2 and the fourth core 2b-2. The intermediate cores 2c1, 2c2, and 2c3 are not provided with teeth protruding toward the inner side in the radial direction.

The first core 2a-1, the intermediate core 2c1, the second core 2a-2, the intermediate core 2c3, the fourth core 2b-2, the intermediate core 2c2, and the third core 2b-1 are stacked and integrated by caulking, adhesion, or combinations of them.

The first teeth 3a1 and the second teeth 3a2 adjacent to each other in the first toque detection part 7a are stacked in staggered arrangement so that the phase differs by +45 degrees in the circumferential direction. The third teeth 3b1 and the fourth teeth 3b2 adjacent to each other in the second torque detection part 7b are stacked in staggered arrangement so that the phase differs by −45 degrees in the circumferential direction.

Accordingly, as shown in the developed view of the core in FIG. 11, the first teeth 3a1 and the second teeth 3a2 formed in staggered arrangement in the first core 2a-1 and the second core 2a-2 of the first torque detection part 7a in the circumferential direction, and the third teeth 3b1 and the fourth teeth 3b2 formed in staggered arrangement in the third core 2b-1 and the fourth core 2b-2 of the second torque detection part 7b in the circumferential direction are stacked in the mirror symmetry with respect to the symmetry plane M. Note that the long frame E surrounding NA and SA represents an inclination of magnetic paths with respect to the axial center direction (the vertical direction in the drawing) in the magnetic paths formed between the object to be detected and the first teeth 3a1/the second teeth 3a2. Similarly, the long frame E surrounding NB and SB represents an inclination of magnetic paths with respect to the axial center direction (the vertical direction in the drawing) in the magnetic paths formed between the object to be detected and the third teeth 3b1/the fourth teeth 3b2.

According to the above configuration, when the first coils 5a of the first torque detection part 7a are energized, the first teeth 3a1 and the second teeth 3a2 adjacent to each other are excited to different magnetic poles (N-pole or S-pole), and a plurality of magnetic paths having the inclination of +45 degrees with respect to the axial center direction are formed between the teeth and the facing object to be detected S. Moreover, when the second coils 5b of the second torque detection part 7b are energized, the third teeth 3b1 and the fourth teeth 3b2 adjacent to each other are excited to different magnetic poles (N-pole or S-pole), and a plurality of magnetic paths having the inclination of −45 degrees with respect to the axial center direction are formed between the teeth and the facing object to be detected S.

Accordingly, generation of compressive stress and tensile stress can be detected over the entire circumference of the object to be detected S. As the plural first teeth 3a1 and second teeth 3a2 are provided to protrude in the annular first core 2a-1 and second core 2a-2 at predetermined intervals in the circumferential direction, and the plural third teeth 3b1 and fourth teeth 3b2 are provided to protrude in the third core 2b-1 and the fourth core 2b-2 at predetermined intervals in the circumferential direction; therefore, the sensor can be manufactured similarly to a stator core (laminated core) of a motor, which can be reduced in size in the radial direction and the axial direction and can be mass produced at low cost.

As shown in FIG. 11, when the second teeth 3a2 and the fourth teeth 3b2 adjacent to each other in the axial center direction through the symmetry plane M are excited to the same magnetic pole in the first torque detection part 7a and the second torque detection part 7b, the second teeth 3a2 and the fourth teeth 3b2 at symmetrical positions in the axial center direction through the symmetry plane M have the same magnetic pole; therefore, the magnetic path is not formed between the second core 2a-2 and the fourth core 2b-2 across the symmetry plane M.

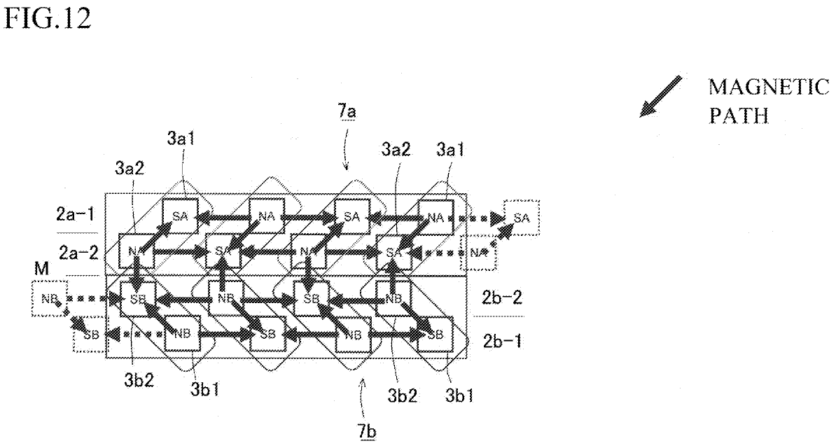

As shown in FIG. 12, when the second teeth 3a2 and the fourth teeth 3b2 adjacent to each other in the axial center direction through the symmetry plane M are excited to different magnetic poles (N-pole or S-pole) in the first detection part 7a and the second torque detection part 7b, the second teeth 3a2 and the fourth teeth 3b2 at symmetrical positions in the axial center direction through the symmetry plane M have different magnetic poles; therefore, magnetic paths are formed between the second core 2a-2 and the fourth core 2b-2 across the symmetry plane M. However, these are magnetic path components making little contribution to torque detection. Accordingly, the detection sensitivity is hardly affected.

Moreover, magnetic paths formed in the circumferential direction between different magnetic poles (NA, SA) (NB, SB) formed in the circumferential direction of the cores 2 (the first core 2a-1, the second core 2a-2, the third core 2b-1, and the fourth core 2b-2) in FIG. 11 and FIG. 12 have magnetic path components making little contribution to torque detection. Accordingly, the detection sensitivity is hardly affected.

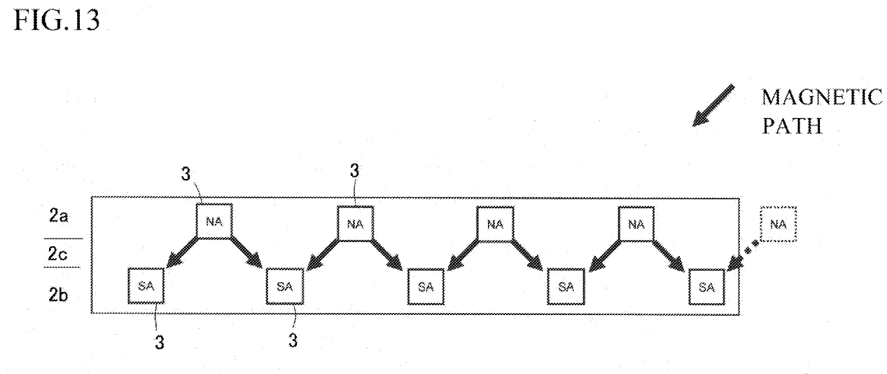

Here, comparative examples with respect to the above embodiments will be explained with reference to FIG. 13 to FIG. 15. Comparative explanation will be made below with reference to developed views of the core.

FIG. 13 is a comparative arrangement view of magnetic poles formed at the teeth by energization, which is not capable of being applied to the torque detection sensor 1 of FIG. 1. As shown in FIGS. 3A and 3B, the adjacent teeth 3 are excited to different poles (N-pole or S-pole) and a plurality of magnetic paths having any of inclinations of +45 degrees and −45 degrees with respect to the axial center direction between the teeth 3 and the facing object to be detected S are formed by energizing the respective coils 5. On the other hand, in FIG. 13, magnetic paths (SA-NA-SA) having inclinations of +45 degrees and −45 degrees with respect to the axial center direction (the vertical direction in the drawing) are respectively formed in teeth 3 adjacent on both sides of the teeth 3 in staggered arrangement in the core 2 (the first core 2a, the second core 2b). In this case, it is difficult to measure the torque since directions of torque components to be measured are opposite.

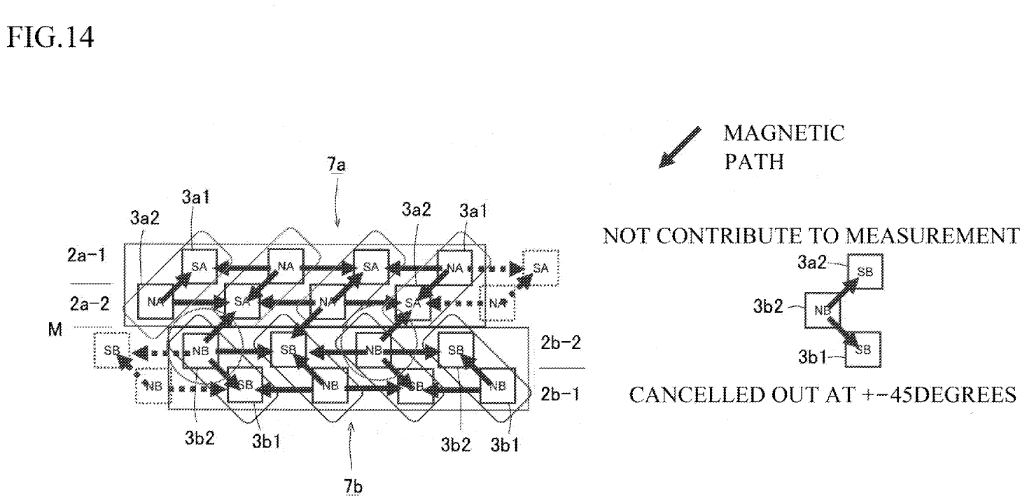

FIG. 14 is a comparative arrangement view of cores and magnetic poles formed at the teeth by energization, which is not capable of being applied to the torque detection sensor 1 of FIG. 9. FIG. 14 shows an arrangement in which the first torque detection part 7a and the second torque detection part 7b in the arrangement view of the magnetic paths and the teeth of the torque detection sensor 1 in FIG. 11 are shifted by one pitch (45 degrees) in the circumferential direction, and the first teeth 3a1 and the second teeth 3a2 in the first torque detection part 7a and the third teeth 3b1 and the fourth teeth 3b2 in the second torque detection part 7b are not arranged in mirror symmetry with respect to the symmetry plane M. In this case, magnetic paths (NB-SA, NA-SB) crossing between the second teeth 3a2 of the second core 2a-2 and the fourth teeth 3b2 of the fourth core 2b-2 at +45 degrees and −45 degrees are formed, and magnetic paths (NB-SA, NA-SB) of +45 degrees and magnetic paths (NB-SB) of −45 degrees are formed from the same magnetic pole (NB, SB); therefore, magnetic fluxes are cancelled out and do not contribute to measurement, which reduces detection sensitivity.

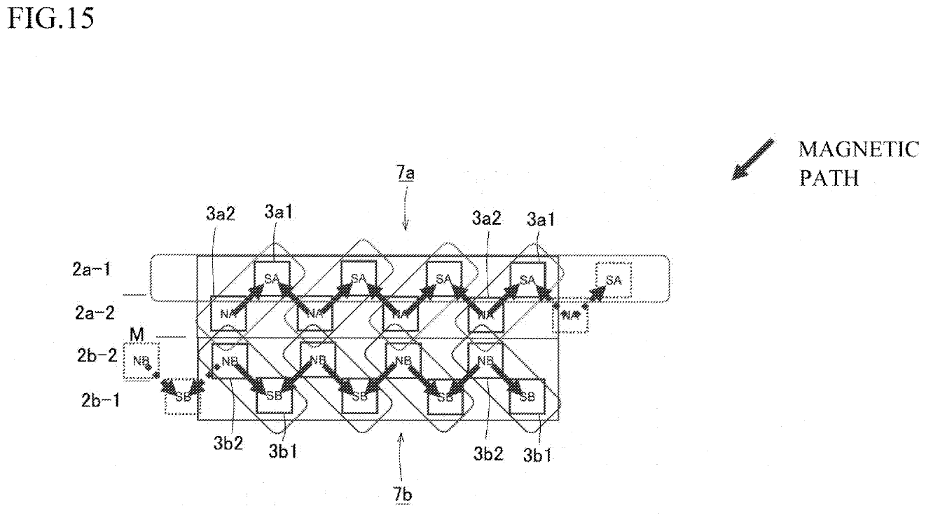

FIG. 15 is a comparative arrangement view of cores and magnetic poles formed at the teeth by energization, which is not capable of being applied to the torque detection sensor 1 of FIG. 9. The first teeth 3a1 and the second teeth 3a2 in the first torque detection part 7a and the third teeth 3b1 and the fourth teeth 3b2 in the second torque detection part 7b are arranged in mirror symmetry with respect to the symmetry plane M in the arrangement view of the magnetic paths and the teeth of the torque detection sensor 1 in FIG. 11; however, the first teeth 3a1 (SA) arranged in the circumferential direction of the first core 2a-1 and the third teeth 3b1 (SB) arranged in the circumferential direction of the third core 2b-1 have the same magnetic pole.

In this case, the magnetic paths of +45 degrees (NA-SA) and the magnetic paths of −45 degrees (NA-SA) are respectively formed between the first teeth 3a1 and the second teeth 3a2 provided in staggered arrangement in the first core 2a-1 and the second core 2a-2, for example, in the first torque detection part 7a. Also, the magnetic paths of +45 degrees (NB-SB) and the magnetic paths of −45 degrees (NB-SB) are respectively formed between the third teeth 3b1 and the fourth teeth 3b2 provided in staggered arrangement in the third core 2b-1 and the fourth core 2b-2 in the second torque detection part 7b. In this case, when the second teeth 3a2 and the fourth teeth 3b2 adjacent to each other in the axial center direction through the symmetry plane M are excited to the same magnetic pole in the first torque detection part 7a and the second torque detection part 7b, the second teeth 3a2 and the fourth teeth 3b2 which are symmetrical positions in the axial center direction of the object to be detected S through the symmetry plane M have the same magnetic pole; therefore, the magnetic path is not formed between the second core 2a-2 and the fourth core 2b-2 across the symmetry plane M. In the first core 2a-1 and the second core 2a-2, the magnetic paths having inclinations of +45 degrees and −45 degrees (SA-NA-SA) with respect to the axial center direction (the vertical direction in the drawing) are respectively formed in teeth adjacent on both sides in the first teeth 3a1 and the second teeth 3a2. Similarly, in the third core 2b-1 and the fourth core 2b-2, the magnetic paths having inclinations of +45 degrees and −45 degrees (SA-NA-SA) with respect to the axial center direction (the vertical direction in the drawing) of the object to be detected S are respectively formed in teeth adjacent on both sides in the third teeth 3b1 and the fourth teeth 3b2. In this case, it is difficult to measure the torque since directions of torque components to be measured are opposite.

As explained above, the plural teeth 3 are provided to protrude in staggered arrangement in the annular core 2 in the circumferential direction; therefore, the sensor can be manufactured in a similar manner to manufacturing processes of the stator core (laminated core) of the motor, which can be reduced in size in the radial direction and can be mass produced at low cost. Moreover, the plural teeth 3 can be provided to protrude in staggered arrangement in the circumferential direction; therefore, generation of compressive stress or tensile stress can be detected over the entire circumference of the object to be detected S.

In the case where the first torque detection part 7a in which the plural magnetic paths having the inclination of +45 degrees with respect to the axial direction of the object to be detected S are formed and the second torque detection part 7b in which the plural magnetic paths having the inclination of −45 degrees with respect to the axial direction of the object to be detected S are formed are stacked in mirror symmetry with respect to the symmetry plane M orthogonal to the axial center direction, generation of compressive stress and tensile stress can be detected over the entire circumference of the object to be detected S.

The torque detection sensor that detects the torque of the object to be detected S which is a solid shaft has been explained in the above embodiments, and it is also preferable to detect the torque of a hollow shaft as the object to be detected S. In this case, the teeth 3 are formed toward an outer side in the radial direction from the annular core back portions 2a1, 2b1 as the shape of the core.

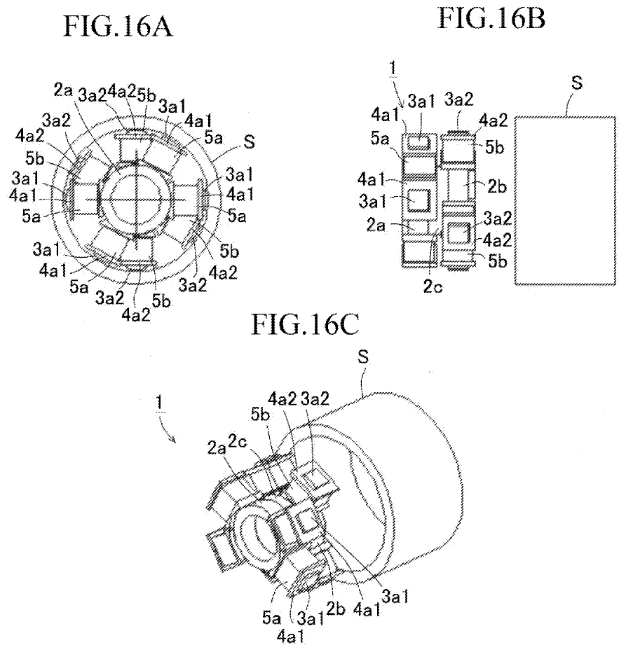

In FIGS. 16A to 16C, the annular first core 2a, intermediate core 2c, and second core 2b are integrally stacked in the core 2. In the first core 2a, for example, four first teeth 3a1 in total are provided to protrude in the annular core back portion 2a1 with a predetermined phase difference in the circumferential direction as well as toward the outer side in the radial direction in opposite positions. In the second core 2b, for example, four second teeth 3a2 in total are provided to protrude in the annular core back portion 2b1 with a predetermined phase difference in the circumferential direction as well as toward the outer side in the radial direction in opposite positions. The first coils 5a are wound around the first teeth 3a1 through the first insulators 4a1, and the second coils 5b are wound around the second teeth 3a2 through the second insulators 4a2. The first core 2a and the second core 2b are stacked through the intermediate core 2c, and the first teeth 3a1 and the second teeth 3a2 are stacked with the phase difference of 45 degrees in the circumferential direction to make, for example, four pairs of teeth.

The above-described torque detection sensor 1 is concentrically inserted into a hollow hole of the object to be detected S (hollow shaft), and the first teeth 3a1 and the second teeth 3a2 are assembled so as to face an inner peripheral surface of the object to be detected S as shown in FIGS. 16B and 16C. Accordingly, magnetic circuits including the object to be detected S are formed between the first teeth 3a1 and the second teeth 3a2 provided in the staggered arrangement as shown in FIG. 16A, and torque variation can be detected from magnetic path components of ±45 degrees.

As described above, the sensor can detect torque variation of not only the solid shaft but also the hollow shaft as the object to be detected S, which improves versatility.

The core 2 and the teeth 3 in the laminated type have been explained; however, the core 2 and the teeth 3 are not limited to this, but may be formed by machining or wire-cutting a block-shaped magnetic material or some other methods.

What is claimed is:

1. A torque detection sensor measuring variation of magnetic permeability by variation of coil impedance in magnetic circuits formed between a core and an object to be detected by energizing coils wound around teeth provided to protrude from the annular core provided around the object to be detected at plural places,
wherein a plurality of teeth are provided to protrude in staggered arrangement in the annular core in a circumferential direction,
the coils are wound around the respective teeth, and
when the respective coils are energized, corresponding teeth are excited to thereby form a plurality of magnetic circuits having an inclination of +45 degrees or −45 degrees with respect to an axial center direction of the object to be detected between the teeth and the facing object to be detected.

2. The torque detection sensor according to claim 1, wherein the coils connected to a same energizing circuit in series are wound around the plural teeth, and
the teeth adjacent in the circumferential direction are alternately excited to N-poles and S-poles.

3. The torque detection sensor according to claim 1, wherein the core includes a first core, an intermediate core, and a second core,
the plural first teeth formed in the first core in the circumferential direction and the plural second teeth formed in the second core in the circumferential direction are stacked through the intermediate core, and
the first teeth and the second teeth are provided to protrude in staggered arrangement in the circumferential direction.

4. The torque detection sensor according to claim 1,
wherein the torque detection sensor is a self-excitation sensor measuring variation of magnetic permeability by variation of coil impedance in magnetic circuits formed between the teeth and the object to be detected by energizing the coils wound around the plural teeth provided to protrude in the core in staggered arrangement.

5. A torque detection sensor measuring variation of magnetic permeability by variation of coil impedance in magnetic circuits formed between a plurality of annular cores provided around an object to be detected and the object to be detected by energizing coils wound around teeth provided to protrude from the plural annular cores at plural places, comprising:
a first torque detection part including a first core, an intermediate core, and a second core, in which a plurality of first teeth formed in the first core in a circumferential direction and a plurality of second teeth formed in the second core in the circumferential direction are stacked through the intermediate core, the first teeth and the second teeth are provided to protrude in the circumferential direction in staggered arrangement, coils are respectively wound around the respective teeth, the teeth are excited by energization to the respective coils, and a plurality of magnetic circuits having an inclination of +45 degrees with respect to an axial center direction are formed between the teeth and the facing object to be detected; and
a second torque detection part including a third core, an intermediate core, and a fourth core, in which a plurality of third teeth formed in the third core in the circumferential direction and a plurality of fourth teeth formed in the fourth core in the circumferential direction are stacked through the intermediate core, the third teeth and the fourth teeth are provided to protrude in the circumferential direction in staggered arrangement, coils are respectively wound around the respective teeth, the teeth are excited by energization to the respective coils, and a plurality of magnetic circuits having an inclination of −45 degrees with respect to the axial center direction are formed between the teeth and the facing object to be detected,
wherein the first torque detection part and the second torque detection part are stacked through an intermediated core so that the first torque detection part and the second torque detection part are arranged in mirror symmetry with respect to a symmetry plane orthogonal to the axial center direction of the object to be detected.

6. The torque detection sensor according to claim 5,
wherein, in the first torque detection part and the second torque detection part, the teeth adjacent to each other in the axial center direction through the symmetry plane are excited to the same magnetic pole.

7. The torque detection sensor according to claim 5,
wherein, in the first torque detection part and the second torque detection part, the teeth adjacent to each other in the axial center direction through the symmetry plane are excited to different magnetic poles.

8. The torque detection sensor according to claim 5,
wherein the first torque detection part and the second torque detection part are self-excitation sensors measuring variation of magnetic permeability by variation of coil impedance in magnetic circuits formed between the teeth and the object to be detected by respectively energizing the coils wound around the teeth provided to protrude in the plural cores in staggered arrangement.
